(19) United States
(12) Patent Application Publication
(10) Pub. No.: US 2006/0109198 A1
(43) Pub. Date: May 25, 2006

(54) Method and apparatus for using picture-in-picture data as an independent display

(76) Inventors: Raymond Chow, Richmond (CA); Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/996,025

(22) Filed: Nov. 23, 2004

(51) Int. Cl. G09G 5/00

(52) U.S. Cl. 345/1.1

(57) ABSTRACT

A display in communication with a first display panel and a second display panel is provided. The display controller includes a memory having main display data and PIP display data, wherein the PIP display data is provided by a camera sensor. Tracking circuitry configured to determine a display position of the main display data within the first display panel and circuitry enabling selection between the main display data and the picture-in-picture display data according to the position are included. The display controller includes a display interface configured to select the first display panel for receiving a transmission when the main display data is being selected. The display interface is further configured to select both the first display panel and the second display panel for receiving a transmission when the picture-in-picture display data is being selected. A device and method for simultaneously displaying data within a PIP window and a display region of a second display are also provided.

### CROSS REFERENCE TO RELATED APPLICATIONS

This application is related to U.S. Patent Publication No. 2002/0057265, filed on Oct. 23, 2001, and entitled “Display Driver, and Display Unit and Electronic Instrument Using the Same,” and U.S. Patent Publication No. 2002/0011998, filed on Jul. 25, 2001, and entitled “RAM-Incorporated Driver, and Display Unit and Electronic Equipment Using the Same.” The disclosures of these applications are incorporated herein by reference in their entirety for all purposes.

### BACKGROUND

1. Field of the Invention

This invention relates generally to computer systems and more particularly to a method and apparatus for simultaneously displaying picture-in-picture (PIP) data in a main display panel and using the PIP data for the entire display for a secondary display panel.

2. Description of the Related Art

The popularity of cell phones with camera capability has spurred continual efforts to increase the functionality provided by the cell phones. Many of the cell phones today are equipped with dual display panels. Currently, cell phones with dual display panels cannot efficiently display live camera video stream simultaneously. One of the obstacles to displaying the data in both display panels simultaneously is the fact that the display controllers have timing limitations that would not allow it to simultaneously refresh both display panels.

As the popularity of cell phones with camera capability continues to rise, the ability to simultaneously utilize both display panels will enhance the functionality of the camera cell phone. Of course, the technique would have to be viable for the limited resources available in terms of computing power and battery life for handheld electronic devices, such as cell phones.

As a result, there is a need to solve the problems of the prior art to provide an apparatus and method to provide the capability to simultaneously utilize the two display panels of a handheld electronic device.

### SUMMARY

Broadly speaking, the present invention fills these needs by providing a method and apparatus for implementing a method and device enabling a picture-in-picture display to act as an independent display for a second panel associated with a common device. It should be appreciated that the present invention can be implemented in numerous ways, including as a method, a system, or a device. Several inventive embodiments of the present invention are described below.

In one embodiment, a method for simultaneously displaying data within a picture-in-picture (PIP) window on a portion of a first display and an entire display region of a second display is provided. The method initiates with identifying a location of the PIP window within the first display. The method includes transmitting main display data and PIP window data to the first display and the second display. The transmitting includes tracking a position of the main display data within the first display and identifying when the position corresponds to the location of the PIP window. In response to identifying when the position corresponds to the location, the PIP window data is transmitted to both the first display and the second display.

In another embodiment, a device is provided. The device includes a first display panel and a second display panel. A display controller in communication with the first and the second display panels is included. The display controller includes a memory having main display data and picture-in-picture display data and tracking circuitry configured to determine a position in a first display where display data is being displayed. The memory further includes circuitry enabling selection between the main display data and the picture-in-picture display data according to the position. A display interface in communication with the first and the second display panels is included within the display controller. The display interface is configured to select the first display panel for receiving a transmission when the main display data is being selected. The display interface is further configured to select the first display panel and the second display panel for receiving a transmission when the picture-in-picture display data is being selected.

In yet another embodiment, a display controller in communication with a first display panel and a second display panel is provided. The display controller includes a memory having main display data and picture-in-picture display data, wherein the picture-in-picture display data is provided by a camera sensor. The display controller includes tracking circuitry configured to determine a position in a first display where display data is being displayed in a raster format and circuitry enabling selection between the main display data and the picture-in-picture display data according to the position. The display controller includes a display interface in communication with the first and the second display panels. The display interface is configured to select the first display panel for receiving a transmission when the main display data is being selected. The display interface is further configured to select both the first display panel and the second display panel for receiving a transmission when the picture-in-picture display data is being selected.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIGS. 1A and 1B illustrate a cell phone having a picture in picture (PIP) display region within a first display panel and a second display panel, wherein the PIP display data encompasses the entire display area of the second display in accordance with one embodiment of the invention.

FIG. 2 is a high level simplified schematic diagram of a device having two display panels wherein one of the display panels acts as a display panel for the PIP display data, while the other display panel incorporates the PIP display data in a desktop environment, in accordance with one embodiment of the invention.

FIG. 3 is a simplified schematic diagram illustrating exemplary components of a display controller in accordance with one embodiment of the invention.

FIG. 4 is a wave form diagram illustrating the signal states when both display panels have the same bit per pixel (bpp) mode in accordance with one embodiment of the invention.

FIG. 5 is a simplified schematic diagram of a wave form illustrating the signal configuration when the two display panels have different bit per pixel modes in accordance with one embodiment of the invention.

FIG. 6 is a flow chart diagram illustrating the method operations for simultaneously displaying data within a picture in picture window on a portion of the first display panel and an entire display region of a second display panel in accordance with one embodiment of the invention.

### DETAILED DESCRIPTION

An invention is described for method and device that enables a picture-in-picture display to act as an independent display for a second panel associated with a common device. It will be obvious, however, to one skilled in the art, that the present invention may be practiced without some or all of these specific details. In other instances, well known process operations have not been described in detail in order not to unnecessarily obscure the present invention.

The embodiments of the present invention provide a method and device that enables a handheld electronic device with camera functionality to simultaneously display data within a sub-window of a main display panel on a secondary panel. Thus, a user is able to view an image being captured through the camera functionality on a desktop environment in the main display panel, while a subject within the field of view of the image being captured may view the captured image through the secondary display panel. The image on the desktop environment is displayed within a picture-in-picture (PIP) window. The main display panel and the secondary display panel are configured to refresh themselves from random access memory (RAM) incorporated into each of the display panels.

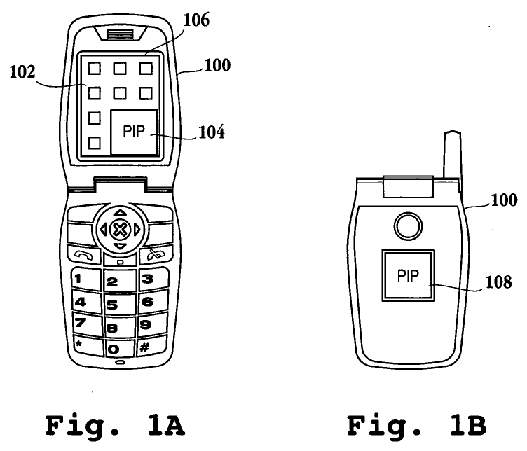

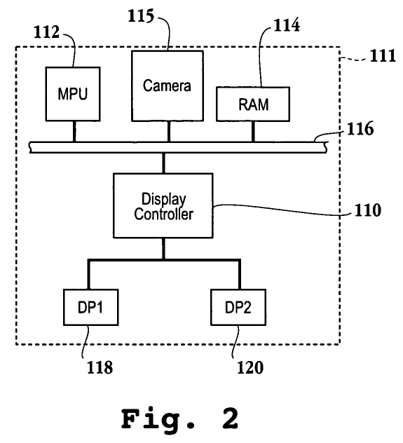

FIGS. 1A and 1B illustrate a cell phone having a picture in picture (PIP) display region within a first display panel and a second display panel, wherein the PIP display data encompasses the entire display area of the second display in accordance with one embodiment of the invention. In FIG. 1A, cell phone 100 is in an open state. Display panel 106 includes two regions, i.e., region 102 and region 104. Region 102 is configured as a desktop environment. For example, region 102 may provide Internet access or may be used as a personal computer desktop application in accordance with one embodiment of the invention. Region 104 includes a display region for the PIP display data. In one embodiment, cell phone 100 has camera capability and an image within the field of view of a suitable image capture device, e.g., a camera sensor, is displayed within region 104. In FIG. 1B, cell phone 100 is in a closed state illustrating display panel 108, in which PIP display data may be presented. Thus, where cell phone 100 includes camera capability, a user having the cell phone open may view an image within the field of view of the camera in region 104, while the subject of the picture may view the scene being observed by the user through display panel 108. It should be appreciated that display panel 108 is on an opposing surface of the cell phone relative to display panel 106.

FIG. 2 is a high level simplified schematic diagram of a device having two display panels wherein one of the display panels acts as a display panel for the PIP display data, while the other display panel incorporates the PIP display data in a desktop environment, in accordance with one embodiment of the invention. Device 111 includes microprocessor unit (MPU) 112, camera block 115, random access memory 114, and display controller 110, each being in communication through bus 116. MPU 112 may be a digital signal processor or central processing unit. Camera block 115 is configured to provide camera capability for device 111. Camera block 115 may include a charged coupled device (CCD) or a complementary metal oxide semiconductor (CMOS) sensor. Display controller 110 controls display panel 1-118 and display panel 2-120. It should be appreciated that display panel 118 and display panel 120 correspond to display panels 106 and 108, respectively, of FIGS. 1A and 1B.

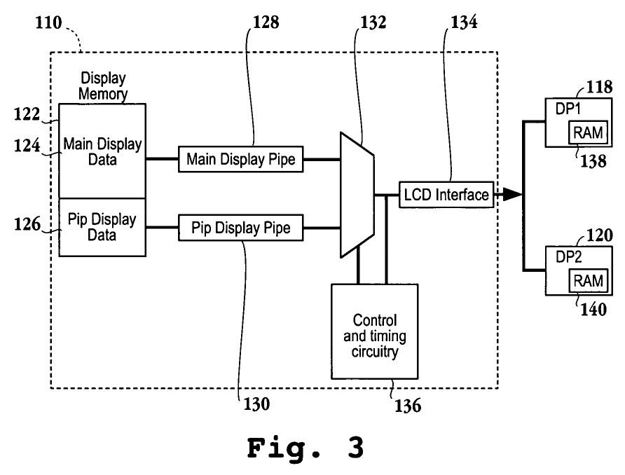

FIG. 3 is a simplified schematic diagram illustrating exemplary components of a display controller in accordance with one embodiment of the invention. Display controller 110 includes display memory 122. Display memory 122 has incorporated therein, main display data 124 and PIP display data 126. Main display data 124 is fetched through main display pipe 128, while PIP display data is fetched through PIP display pipe 130. Multiplexor 132 is used to select between main display data 124 and PIP display data 126 for output to interface 134. It should be appreciated that in one embodiment, display controller 110 is a liquid crystal display (LCD) controller.

Still referring to FIG. 3, the selection of main display data 124 and PIP display data 126 is controlled by control and timing circuitry block 136. Control and timing circuitry block 136 will track the display of image data on the main display panel in order to determine when to output main display data 124 or PIP display data 126. As the data is displayed in a raster format, counters will track the horizontal and vertical position as each pixel of the display is selected, in order to determine a position being displayed in the raster sequence on the main display panel. Here, reference to the main display panel refers to display panel 106 and reference to the PIP display panel refers to display panel 108 of FIGS. 1A and 1B. Thus, the location of the PIP window, i.e., the coordinates of the PIP window, within the main display panel is known and the coordinates being displayed are being tracked through control and timing circuitry block 136. As the main display panel, e.g., display panel 118, begins to display the PIP window data, control and timing circuitry block 136 switches a logical state for a select signal to multiplexor 132 in order to output PIP display data 126. It should be noted that control and timing circuitry block 136 and multiplexor 132 may be referred to as tracking circuitry. The illustration of FIG. 3 shows the control and timing circuitry that selects between Main and PIP data. It should be appreciated that this can be further extended to include logical blending of the main display data and the PIP data as well.

Still referring to FIG. 3, display interface 134 will then provide chip select signals to each of display panels 1 and 2, 118 and 120, in order to prepare the panels for receiving the PIP display data 126. Interface 134 triggers and controls the timing of display data as it is transferred on to display panels 118 and 120. Control and timing circuitry block 136 provides some timing information to interface 134 in order for the interface to drive the panel chip select signals so as to display data to either or both panels. In one embodiment, display panel 1-118 and display panel 2-120 include random access memory (RAM) integrated therein. As illustrated, display panel 1 incorporates RAM 138, while display panel 2-120 incorporates RAM 140. With the RAM incorporated therein, each of display panel 1-118 and display panel 2-120 can refresh from RAM 138, and 140, respectively. Further information of RAM integrated panels may be found in U.S. Patent Publication No. 2002/0057265 and U.S. Patent Publication No. 2002/0011998, both of which have been incorporated by reference.

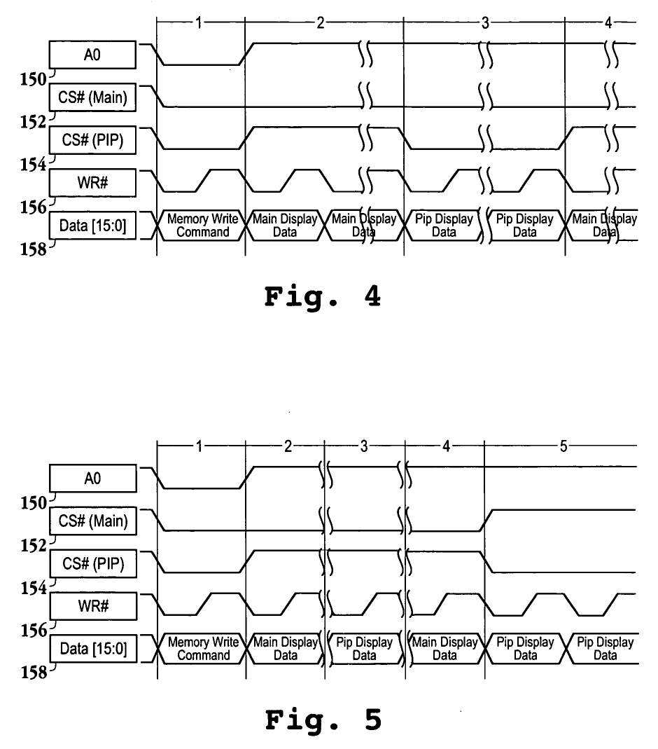

FIG. 4 is a wave form diagram illustrating the signal states when both display panels have the same bit per pixel (bpp) mode in accordance with one embodiment of the invention. The signals represented include address select signal (A0) 150, chip select signal (CS#) for the main display panel 152, CS# for the picture-in-picture display panel 154 and write enable signal 156. A0 signal 150 in this case is a index or register select signal. Assertion of A0 signal 150 during a panel bus transfer indicates that the bus transfer is for commands or register settings to be programmed to the panel. De-assertion of A0 signal 150 indicates raw pixel data as indicated in cycles 2-4. During cycle one, memory write commands are issued to both panels at the same time to indicate that display data will be coming. Here, both chip select signals 152 and 154 are asserted in order to receive the memory write command. As discussed above, each display panel has RAM integrated therein, thus the memory write commands indicate that display data will be coming to the integrated RAM. It should be appreciated that the write commands can be issued individually to each panel, e.g., where the two panels are of a different command set. In this case, one write command is issued to a first display panel with it's associated chip select signal asserted, then another write command is issued to the second panel with it's associated chip select signal asserted. In cycle 2, A0 signal 150 is de-asserted, i.e., goes high, as well as CS# for the picture-in-picture display 154. Thus, main display data fetched from the main display pipe is written to the main display panel, as chip select signal for the main display panel 152 remains asserted.

In cycle three of FIG. 4, the PIP display data fetched from the PIP display pipe is written to both the main display panel and the small display panel, i.e., the PIP display panel, as both chip select signals 152 and 154 are asserted. It should be appreciated that as the raster scan proceeds and the tracking circuitry tracks the position of the pixel being displayed, the display data will eventually reach the coordinates for the PIP display window within the main display panel. At this point, the PIP display data will be transmitted to both display panels, i.e., the main display and the PIP display, simultaneously. Referring to FIG. 3, the counters within control and timing circuitry block 136 would indicate that the coordinates for the PIP window within the main display data are due for display. Accordingly, the select signal to multiplexor 132 would transition to select the data from PIP display pipe 130. Returning to FIG. 4, as mentioned above, CS# signals 152 and 154 are both asserted to cause the PIP data to be received by the corresponding display panels. In cycle four, when the PIP display data is finished, the main display data will continue to be written to the main display panel, while the chip select for the small panel will be de-asserted. The data being transmitted in each cycle is illustrated as associated with data [15:0] line 158.

FIG. 5 is a simplified schematic diagram of a wave form illustrating the signal configuration when the two display panels have different bit per pixel modes in accordance with one embodiment of the invention. In cycle one, the memory write command is written to both panels at the same time to indicate display data will be coming. Here, both chip select signals 152 and 154 are asserted similar to FIG. 4. In cycle two, main display data from the main display pipe is written into the main display panel. Chip select signal for the main display panel 152 is asserted, while chip select signal for the PIP display panel 154 is de-asserted. In cycle three, PIP display data from the PIP display pipe is written to the main display panel only, since the two display panels have different bit per pixel modes, and chip select signal 154 is not asserted. In cycle four, when the PIP display data has finished, e.g., for the horizontal line of data, the main display data will continue to be written to the main display panel. Thereafter, in cycle five, after the entire image data, i.e., the main display data and the PIP display data, has been written into the main display panel, PIP display data will be written into the small panel. Here, chip select signal 152 for the main display panel is de-asserted and chip select signal 154 for the small display panel is asserted. It should be appreciated that the signals of FIGS. 4 and 5 being illustrated as active in a low state is not meant to be limiting. That is, the signals may be active in a high state in one embodiment.

In the case where the two panels have different native raw pixel data formats, since the panel interface data lines are shared. The data pertaining to each panel must be sent separately with only the corresponding panel chip select asserted at a time, excluding the panel index or register commands, i.e., A0 is driven LOW, which is typically common to both. For example if LCD1 is 16-bit RGB565 format, the 1 pixel data will be cycled on to the Data [15:0] as most significant bit (MSB) R₄R₃R₂R₁R₀ G₅G₄G₃G₂G₁G₀B₄B₃B₂B₁B₀. If LCD2 is 12-bit RGB444 format, the 1 pixel data will be cycled on to the Data[15:0] as MSB XXXR₃R₂R₁R₀G₃G₂G₁G₀B₃B₂B₁B₀ (X denotes don't cares). It should be appreciated that since the RGB565 and the RGB444 data formats are incompatible, the same data cannot be sent to both panels.

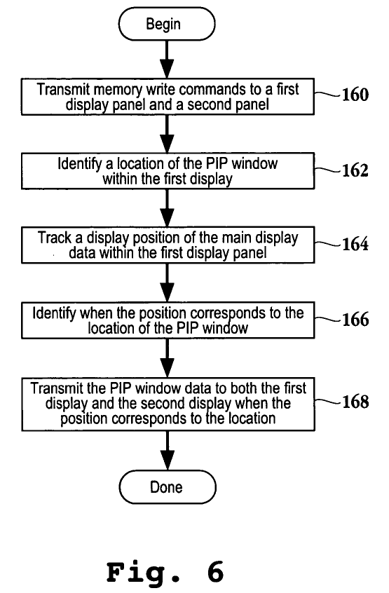

FIG. 6 is a flow chart diagram illustrating the method operations for simultaneously displaying data within a picture in picture window on a portion of the first display panel and an entire display region of a second display panel in accordance with one embodiment of the invention. The method initiates with operation 160 where memory write commands are transmitted to a first display panel and a second display panel. With reference to FIGS. 4 and 5, the memory write commands are issued to the display panels having integrated RAM in order to prepare the display panels to receive the data. In one embodiment, the memory write commands are issued to logic embedded within the display panel associated with the integrated RAM. The method then advances to operation 162 where a location of the PIP window within the first display is identified. Referring to FIG. 1A, the coordinates for the PIP window within the main display panel are identified in order to be able to switch between data fetched by the main display pipe and the PIP display pipe. The method then proceeds to operation 164 where a display position of the main display data within the first display panel is being tracked. Here, the raster scan will proceed in a left to right manner and a top to bottom manner, and as each position, or pixel, is being activated, the display data will be fetched from the corresponding region within the display memory according to a select signal as discussed with reference to FIG. 3. The method then moves to operation 166 and the position corresponding to a location within the PIP window is identified during the raster scan in order to activate an enable bit that selects the PIP display data, as explained with reference to FIG. 3. Selection of the PIP display data results in the chip select signals, with reference to FIGS. 4 and 5, being manipulated. In one embodiment, the chip select signals are asserted for both the main display panel and the PIP display panel so that the PIP display data is transmitted to both the first display and the second display, as illustrated in operation 168. Thus, when the position of the raster scan corresponds to any location within the PIP window, the PIP display data is transmitted to both the main display panel and the PIP display panel.

While the embodiments discussed above describe the PIP display panel having the same size as the PIP window, it should be appreciated that the PIP display panel may have a different size than the PIP display window. In this case, the PIP window data can be cropped and scaled by the dimensions for the second display panel. One skilled in the art will appreciate that a cropping and resizer block downstream of the display interface, with reference to FIG. 3, can accomplish this functionality. In summary, the embodiments described above enable a user of a cell phone camera to view window displays and a live camera image on a main LCD panel. The second LCD panel can also be made simultaneously display the camera image to a subject facing away from the cell phone. Thus, the person being recorded or photographed can also view the recorded image on the second panel facing away from the first person taking the photograph. It should be noted that the embodiments described above are discussed with reference to a cell phone having camera capability. This is not meant to be limiting as the embodiments may be incorporated into any handheld electronic device having dual display panels, e.g., a personal digital assistant, a web tablet, a pocket personal computer, etc.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for simultaneously displaying data within a picture-in-picture (PIP) window on a portion of a first display and an entire display region of a second display, comprising method operations of:
identifying a location of the PIP window within the first display;
transmitting main display data and PIP window data to the first display and the second display, the transmitting including,
tracking a position of the main display data within the first display;
identifying when the position corresponds to the location of the PIP window;
in response to identifying when the position corresponds to the location, transmitting the PIP window data to both the first display and the second display.

2. The method of claim 1 wherein an amount of bits per pixel associated with the main display data and an amount of bits per pixel the PIP window data are identical.

3. The method of claim 1 wherein a size associated with the first display and a size associated with the second display are identical.

4. The method of claim 1 further comprising:
asserting a signal causing data to be transmitted to the first display when the position does not correspond to the PIP window; and
de-asserting a signal preventing data from being transmitted to the second display when the position does not correspond to the PIP window.

5. The method of claim 1 further comprising:
asserting a signal causing data to be transmitted to the first display when the position corresponds to the PIP window; and
asserting a signal preventing data from being transmitted to the second display when the position corresponds to the PIP window.

6. The method of claim 1, further comprising:
issuing memory write commands to embedded logic of each of the first and the second display panels to indicate display data transmission to the display panels.

7. A device, comprising:
a first display panel;
a second display panel; and
a display controller in communication with the first and the second display panels, the display controller including,
a memory having main display data and picture-in-picture display data;
tracking circuitry configured to determine a position in a first display where display data is being displayed;
circuitry enabling selection between the main display data and the picture-in-picture display data according to the position;
a display interface in communication with the first and the second display panels, the display interface configured to select the first display panel for receiving a transmission when the main display data is being selected, the display interface further configured to select the first display panel and the second display panel for receiving a transmission when the picture-in-picture display data is being selected.

8. The device of claim 7, wherein the display interface is configured to issue corresponding chip select signals to the first and second display panels, the chip select signals configured to indicate selection of the first and second display panels.

9. The device of claim 7, wherein each of the first display panel and the second display panel incorporate random access memory.

10. The device of claim 7, wherein the device is a cellular telephone having camera capability.

11. The device of claim 7, wherein the first panel and the second panel are located on opposing surfaces of the device.

12. The device of claim 7, further comprising:
a central processing unit (CPU) in communication with the display controller.

13. The device of claim 10, wherein the picture-in-picture display data is provided by a camera sensor and the main display data is a graphical user interface associated with a desktop computing environment.

14. A display controller in communication with a first display panel and a second display panel, comprising:
a memory having main display data and picture-in-picture display data, the picture-in-picture display data provided by a camera sensor;
tracking circuitry configured to determine a position in a first display where display data is being displayed in a raster format;
circuitry enabling selection between the main display data and the picture-in-picture display data according to the position;
a display interface in communication with the first and the second display panels, the display interface configured to select the first display panel for receiving a transmission when the main display data is being selected, the display interface further configured to select the first display panel and the second display panel for receiving a transmission when the picture-in-picture display data is being selected.

15. The display controller of claim 14, wherein the tracking circuitry includes,
a multiplexor having a select signal received from tracking and control circuitry, the tracking and control circuitry counting a horizontal position and a vertical position of the data being displayed in the raster format, thereby defining the position.

16. The display controller of claim 14, wherein a size of the picture-in-picture display data is identical to a size of the second display panel.

17. The display controller of claim 14, wherein the display interface is configured to issue memory write commands to control logic of the first and the second display panels.

18. The display controller of claim 15, wherein when the position is outside a picture-in-picture display area of the first panel the circuitry enabling selection between the main display data and the picture-in-picture display data is configured to select the main display data.

19. The display controller of claim 15, wherein when the position is inside a picture-in-picture display area of the first panel the circuitry enabling selection between the main display data and the picture-in-picture display data is configured to select the picture-in-picture display data.
